(19) United States
(12) Patent Application Publication
(10) Pub. No.: US 2020/0408550 A1
(43) Pub. Date: Dec. 31, 2020

(54) GENERATING SPATIAL AREAS OF INFLUENCE

(71) Applicant: Uber Technologies, Inc., San Francisco, CA (US)

(72) Inventors: Kapil Gupta, Sunnyvale, CA (US); Jeremy Hintz, Mountain View, CA (US); Kevin Chang, Saratoga, CA (US); Susmit Biswas, San Mateo, CA (US); Houtan Shirani-Mehr, Santa Clara, CA (US)

(21) Appl. No.: 16/910,904

(22) Filed: Jun. 24, 2020

Related U.S. Application Data
(60) Provisional application No. 62/866,341, filed on Jun. 25, 2019.

(51) Int. Cl. G01C 21/34; G06F 16/29

(52) U.S. Cl. CPC G01C 21/3476; G08G 1/202; G06F 16/29

(57) ABSTRACT

Systems and methods are provided for accessing at least one data store comprising activity points for a first place and determining selected activity points to use to generate one or more area of influence (AOI) geometries. The systems and methods further provide for generating one or more AOI geometries using the selected activity points and using an AOI tuple associated with the first place, by performing operations comprising generating one or more clusters of data points corresponding to the selected activity points and generating one or more polygons for each of the one or more clusters of data points. The one or more AOI geometries are associated with the first place, each of the one or more AOI geometries comprising each of the one or more polygons.

### BACKGROUND

A place in a navigation or mapping context is a point of interest (e.g., restaurant, park, mall, building, museum, airport), an address, or the like. Typically, a place may be associated with textual attributes, such as a name, geographical coordinates (e.g., latitude and longitude), a category, and so forth. Textual attributes, however, may have some shortcomings and cause inaccuracies in certain scenarios.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 illustrates an example of a block comprising parcels, building footprints, and places, according to some example embodiments.

FIG. 3 illustrates an example hierarchy of map area types for a place, according to some example embodiments.

FIG. 4 shows an example diagram illustrating an area of influence (AOI) generation pipeline, according to some example embodiments.

FIG. 5 illustrates operations for conflating map feature sets to create an AOI tuple set, according to some example embodiments.

FIG. 6 illustrates operations for matching and adding a new map feature set to an AOI tuple set, according to some example embodiments.

FIG. 7 is a flowchart illustrating aspects of a method, according to some example embodiments.

FIGS. 8A, 8B, 9A, and 9B illustrate example blocks, parcels, building footprints, and activity points, for a place, according to some example embodiments.

FIGS. 10-11 illustrate example AOI geometries, according to some example embodiments.

FIG. 12 illustrates example Voronoi geometries for different places in a block, according to some example embodiments.

FIG. 13 is a block diagram illustrating an example of a software architecture that may be installed on a machine, according to some example embodiments.

FIG. 14 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to generating spatial areas of influence for a place or location. An area of influence is a region around a place where its activity occurs (e.g., rider pickup, rider drop-off, food delivery, package delivery, entry and exit of a building). As explained above, a place is a point of interest (e.g., restaurant, park, mall, building, museum, airport), an address, or the like. Typically, a place may be associated with textual attributes, such as a name, geographical coordinates (e.g., latitude and longitude), a category, and so forth. Textual attributes, however, may have some shortcomings. In one example, reverse geocoding may use a nearest parcel (e.g., a predefined tract or plot of land) to a place as an anchor point to determine a rider pickup location in a navigation system or ride sharing system. This approach, however, may lead to inaccuracy in cases of uncertainty. For example, a parcel may contain multiple places, especially in a city. For example, the parcel may contain two restaurants, a coffee shop, headquarters for a business, a library, and a bank.

In another example, when a ride sharing trip is created, the ride sharing application or system communicates pickup and drop-off locations to the driver and rider through coordinates and addresses. This approach can be enhanced using area of interest or areas of influence (AOI) geometries, as described in example embodiments herein, by allowing users to see the AOI of the locations and giving them a choice to select suitable segments for pickup, for example. In this example, users are given some context about the nature of a location.

In example embodiments, an AOI or AOI geometry is a spatial area associated with a place and which is influencing its surrounding. For example, an area of influence is a region around a place where its activity (e.g., rider pickup, rider drop-off, food delivery, package delivery, entry and exit of a building) occurs. Example embodiments provide systems and methods for generating spatial areas (e.g., one or more polygons) indicating one or more AOIs for a place. An AOI can alleviate uncertainty by explicitly defining regions around a place where activity is expected to occur. An AOI can be used as a place attribute, but instead of text, comprises a spatial area (e.g., in the form of a polygon).

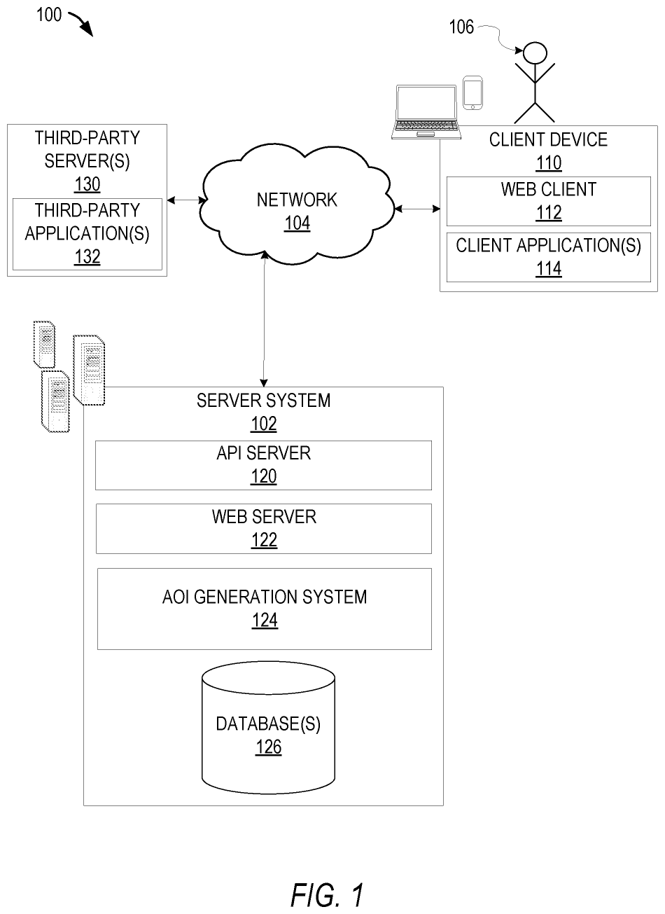

FIG. 1 is a block diagram illustrating a networked system 100, according to some example embodiments. The system 100 includes one or more client devices such as client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touchscreens, accelerometers, gyroscopes, cameras, microphones, Global Positioning System (GPS) devices, and so forth. The client device 110 may be a device of a user that is used to request map information, provide map information, request navigation information, receive and display results of map and/or navigation information, request data about a place or entity in a particular location, receive and display data about a place or entity in a particular location, receive and display data about a pickup or drop-off location, receive and display data related to navigation to a pickup or drop-off location, receive and display information related to an AOI, and so forth.

One or more users 106 may be a person, a machine, or other means of interacting with the client device 110. In example embodiments, the user 106 is not part of the system 100 but interacts with the system 100 via the client device 110 or other means. For instance, the user 106 provides input (e.g., touchscreen input or alphanumeric input) to the client device 110 and the input may be communicated to other entities in the system 100 (e.g., third-party servers 130, server system 102) via a network 104. In this instance, the other entities in the system 100, in response to receiving the input from the user 106, communicate information to the client device 110 via the network 104 to be presented to the user 106. In this way, the user 106 interacts with the various entities in the system 100 using the client device 110. In some example embodiments, the user 106 is a rider in a ride-sharing service, a driver in a ride-sharing service, a person desiring information about a rider pick-up location, a person desiring navigation information, or the like.

The system 100 further includes the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WIFI network, a WiMax network, another type of network, or a combination of two or more such networks.

The client device 110 accesses the various data and applications provided by other entities in the system 100 via a web client 112 (e.g., a browser, such as the Internet Explorer® browser developed by Microsoft® Corporation of Redmond, Wash. State) or one or more client applications 114. The client device 110 includes the one or more client applications 114 (also referred to as “apps”) such as, but not limited to, a web browser, a messaging application, an electronic mail (email) application, an e-commerce site application, a mapping or location application, a ride-sharing application, a navigation application, and the like.

In some embodiments, the one or more client applications 114 may be included in the client device 110, and configured to locally provide a user interface and at least some of the functionalities, with the client applications 114 configured to communicate with other components or entities in the system 100 (e.g., third-party servers 130, server system 102), on an as-needed basis, for data and/or processing capabilities not locally available (e.g., to access location information, to request a pickup or drop-off location, to access navigation information, to access AOI information, to authenticate the user 106, to verify a method of payment). Conversely, the one or more client applications 114 may not be included in the client device 110, and the client device 110 may use its web browser to access the one or more applications hosted on other entities in the system 100 (e.g., third-party servers 130, server system 102).

The server system 102 provides server-side functionality via the network 104 (e.g., the Internet or a wide area network (WAN)) to one or more third-party servers 130 and/or one or more client devices 110. The server system 102 may include an application programming interface (API) server 120, a web server 122, and an AOI generation system 124, that are communicatively coupled with one or more databases 126.

The one or more databases 126 are storage devices that store data related to one or more of source code, navigation data, pick-up and drop-off locations, AOI tuples, AOI geometry, and so forth. The one or more databases 126 may further store information related to the third-party servers 130, third-party applications 132, the client device 110, the client applications 114, the user 106, and so forth. The one or more databases 126 may be cloud-based storage.

The server system 102 is a cloud computing environment, according to some example embodiments. The server system 102, and any servers associated with the server system 102, are associated with a cloud-based application, in one example embodiment.

The AOI generation system 124 provides back-end support for the third-party applications 132 and the client applications 114, which may include cloud-based applications. The AOI generation system 124 generates AOI geometry, among other functionality, as described in further detail below. The AOI generation system 124 comprises one or more servers or other computing devices or systems.

The system 100 further includes one or more third-party servers 130. The one or more third-party servers 130 comprise one or more third-party applications 132. The one or more third-party applications 132, executing on the third-party server(s) 130, interact with the server system 102 via a programmatic interface provided by the API server 120. For example, the one or more third-party applications 132 may request and utilize information from the server system 102 via the API server 120 to support one or more features or functions on a website hosted by a third party or an application hosted by the third party. In one example, a third-party application 132 may request and receive AOI geometry data via the server system 102 and the AOI generation system 124.

Example embodiments comprise a pipeline to generate AOI geometry for places. The pipeline creates AOI geometries for each place that indicates where the place's AOI (e.g., region of influence) is located. The AOI geometry generated by the pipeline captures a “reasonable” region surrounding a place, based on the place's geometric shape(s) and regions of significant activity (e.g., pickup activity, drop-off activity, delivery activity).

Example embodiments establish a relative hierarchy of map area types. In one example embodiment, map area types comprise at least one of a block, a parcel, or a building footprint. Various base map datasets from companies that generate this data, from government sources, and/or from data generated by the server system 102, can be used to determine parcels, blocks, and building footprints for a geographical area. Typically, parcels are contained within blocks, building footprints are contained within parcels, and places are contained within building footprints.

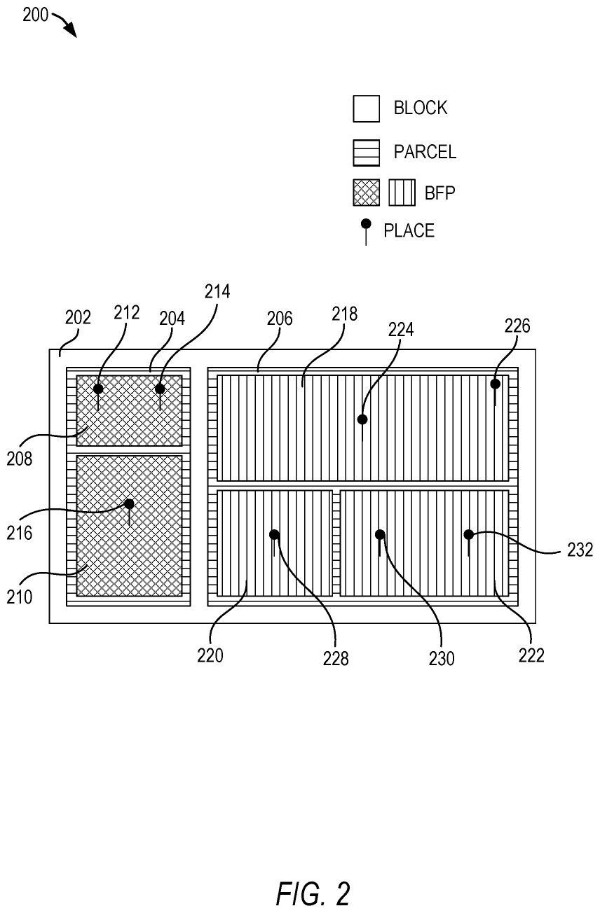

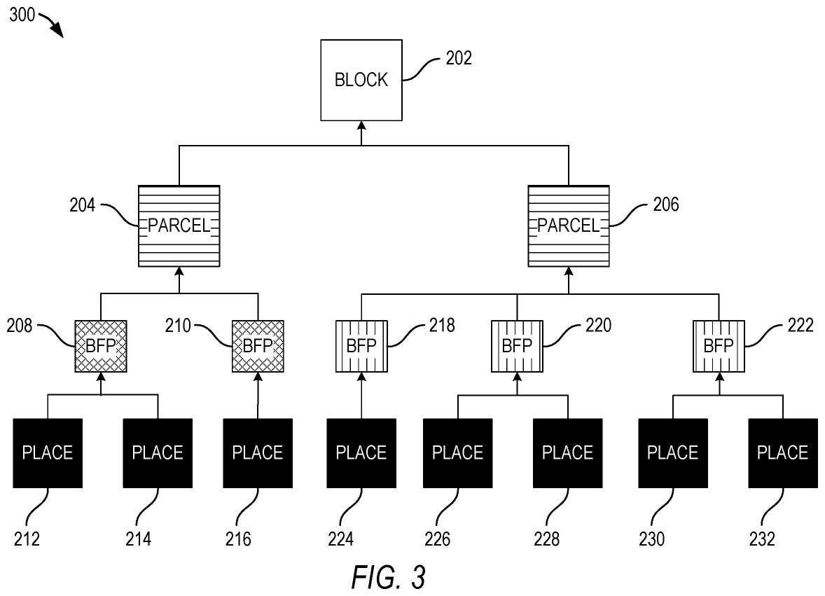

FIG. 2 illustrates an example 200 of a block 202 comprising two parcels 204 and 206, several building footprints (BFPs), and several places. The parcel 204 comprises two building footprints 208 and 210, and three places 212, 214, 216. The parcel 206 comprises three building footprints 218, 220, and 222, and five places 224, 226, 228, 230, and 232. This example can be represented in a hierarchy of area types for a place, such as the example hierarchy 300 shown in FIG. 3. Note that in other examples there may be missing entities. For example, a BFP may be missing, in which case, the place(s) would be directly under the parcel. In another example, parcel information may be missing, and thus, the BFPs are directly under the block, and so forth.

For each place, the hierarchy 300 allows example embodiments to conflate relevant map features at each level (e.g., BFP, parcel, and block) and populate an AOI tuple, which is described below. A relevant map feature is any map feature that may be an ancestor of a place. For example, all BFPs that a place intersects are relevant, all parcels the relevant BFPs intersect are relevant, and all the blocks the relevant parcels intersect are relevant. In cases where there are multiple intersections, example embodiments create a merged map feature.

Based on the hierarchy of map area types, example embodiments set a maximum boundary of a place's AOI to be the oldest or highest (e.g., largest area) map area type associated with the place. For example, the highest or largest area in the example in FIG. 3 would be the block 202 (root node) of the hierarchy 300. The maximum boundary constrains how far an AOI can grow and sets the area of where neighbors can be found. This means that typically a place's maximum boundary (e.g., oldest or highest map area type) is a block since the block usually has the largest geometry.

To generate AOI geometries, various datasets can be used. As explained above, this can include base map data comprising data from one or more data sources such as companies that provide map data, map data generated by the server system 102, government sources that provide map data, and so forth. Other datasets include data for activity points for a place, such as pickup and drop-off points (e.g., locations where riders were picked up by one or a plurality of vehicles or dropped off by one of a plurality of vehicles), food delivery points, package delivery points, and so forth. For example, a ride sharing service may generate data for each pickup and drop-off location for a rider to and from a place and store the pickup and drop-off locations (points) for the place. In another example, the ride sharing service can generate data for request locations corresponding to locations where the ride was requested. For instance, a ride may be requested by a user device inside a building for a pickup location outside the building. In one example embodiment, the activity points are stored in a place profile for a place. In one example embodiment, the activity points are stored for a predefined period of time (e.g., three months, most recent two weeks).

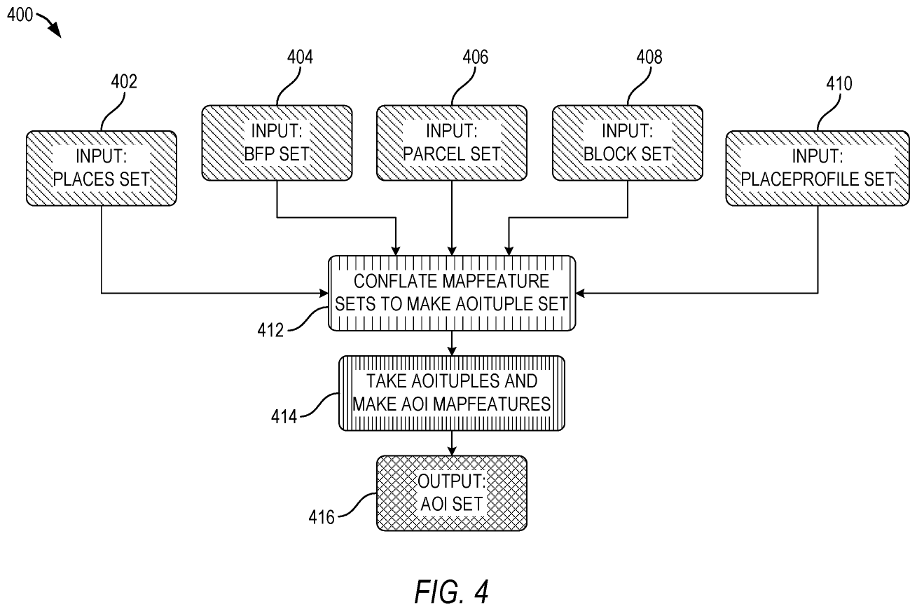

In one example embodiment, the AOI generation system 124 conflates base map data, place data, and activity points in the form of AOI tuples. The AOI generation system 124 then takes the AOI tuples to generate the AOI geometry for one or more places. FIG. 4 shows an example diagram 400 illustrating the AOI generation pipeline, according to one example embodiment. In the example diagram 400, the AOI generation pipeline first conflates all the ingested datasets (e.g., input sets 402-410) in the form of AOI tuples at block 412, and then creates AOI geometries from the AOI tuples at block 414. The output of the AOI generation pipeline is an AOI set at block 416.

In one example, an AOI tuple comprises the below listed information. In one example, a MapFeature is a schema to store map related data (e.g., geometries, physical spaces, points of interests (POIs), addresses).

### AOITuple:

String: Id (unique place identifier)

MapFeature: Place

MapFeature: BFP (merged)

MapFeature: Parcel (merged)

MapFeature: Block (merged)

PlaceProfile: PlaceProfile (contains activity dataset)

List<AOITuple>: Neighbors

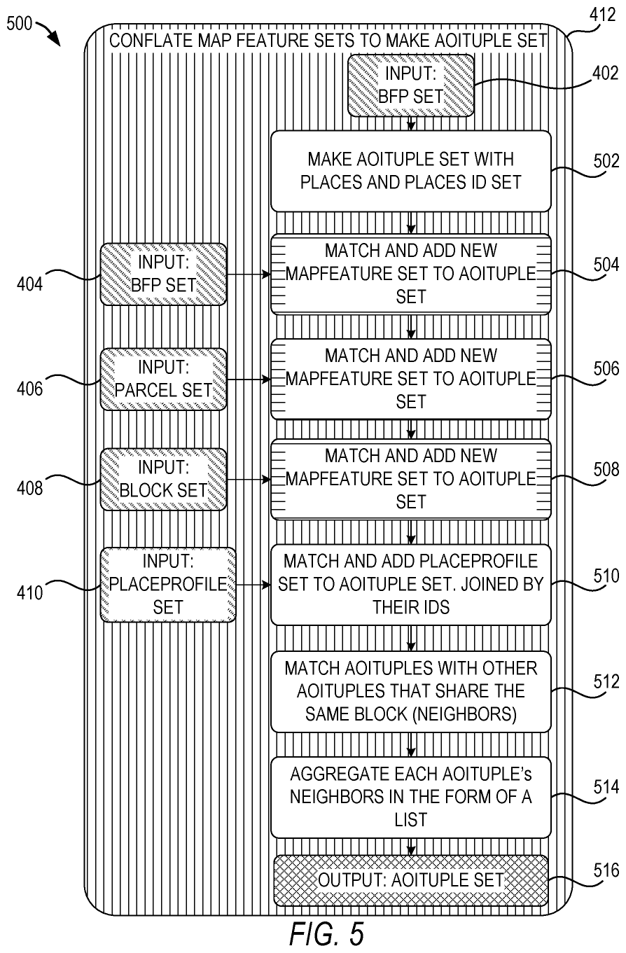

FIG. 5 illustrates the operations for block 412 for conflating MapFeature sets to create an AIO tuple set. In operation 502, the AOI generation system 124 (e.g., via one or more processors of a computing device, server computer, or computing system), for each ingested place, creates a new AOI tuple and populates the ID and Place fields with the unique identifier of the ingested place and the ingested place itself, from the places set 402.

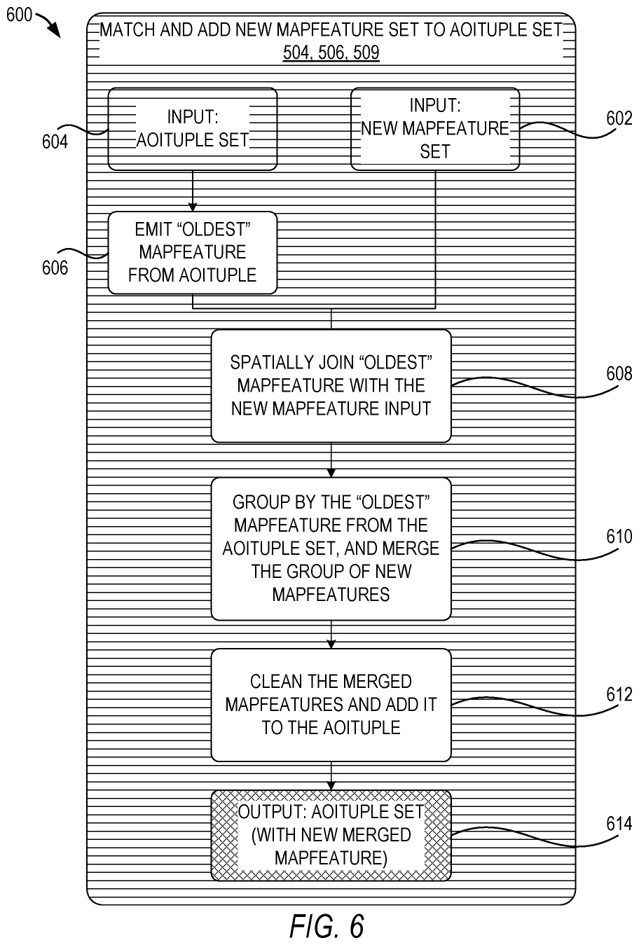

In operation 504, the AOI generation system 124 matches and adds a new map feature set to the AOI tuple set using the BFP set 404; in operation 506, the AOI generation system 124 matches and adds a new map feature set to the AOI tuple set using the parcel set 406; and in operation 508, the AOI generation system 124 matches and adds a new map feature set to the AOI tuple set using the block set 408. The details for each of these operations is shown in FIG. 6. In operation 606, the AOI generation system 124 emits the oldest map feature from the AOI tuple set 604, and in operation 608, the AOI generation system 124 spatially joins the oldest map feature with the new map feature input 602 (e.g., BFP set 404, parcel set 406, or block set 408). In operation 610, the AOI generation system 124 groups by the older map feature from the AOI tuple set and merges the group of new map features. For example, there may be cases where there are multiple BFPs, parcels, and/or blocks. If so, the BFPs are merged, the parcels are merged, and/or the blocks are merged. There also may be cases where an AOI tuple is not matched with any BFP or parcel. In this case, the BFP or parcel field can be set to null.

In one example, not all information specified in the AOI tuple may be available for a place. For example, in the United States there is a lot of data on blocks, parcels, and BFPs. In other countries, however, there may not be any parcel data or even BFP data. In many cases, at least a block can be determined based on road geometries. Thus, in these situations, one or more of the fields in the AOI tuple (e.g., block, parcel, BFP) may be blank or null.

In operation 612, the AOI generation system 124 cleans the merged map features and adds it to the AOI tuple. At operation 614, the output is the AOI tuple set with the new merged map feature.

Returning to FIG. 5, in operation 510, the AOI generation system 124 matches and adds place profile set 410 to the AOI tuple set (e.g., to their respective AOI tuple), and joins them by their unique identifiers. In operation 512, AOI tuples are matched with other AOI tuples that share the same block (e.g., neighbors). In operation 514, the AOI generation system 124 aggregates each AOI tuple's neighbors in the form of a list. For example, the AOI generation system 124 finds the neighbors of each AOI tuple and adds these neighbors to the AOI tuple. In one example embodiment, a neighbor is defined as an AOI tuple that shares the same block as the AOI tuple of interest. At operation 516, the output is the AOI tuple set.

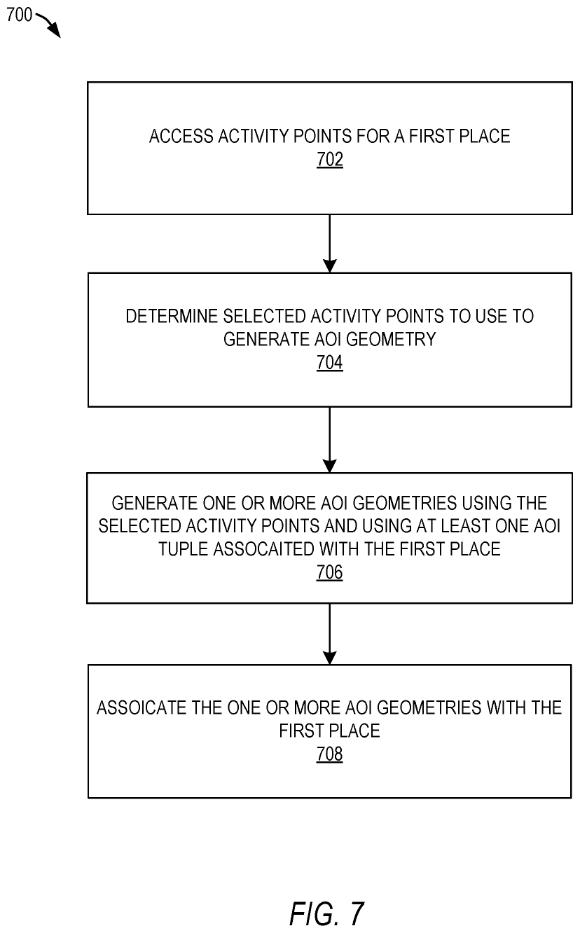

FIG. 7 is a flowchart illustrating aspects of a method 700 for generating an AOI geometry, according to some example embodiments. For illustrative purposes, the method 700 is described with respect to the networked system 100 of FIG. 1. It is to be understood that the method 700 may be practiced with other system configurations in other embodiments.

In operation 702, one or more processors of a computing system (e.g., a server system, such as the server system 102 or the AOI generation system 124), accesses activity points for a place (e.g., a first place). For example, the computing system accesses at least one data store (e.g., database 126) comprising activity points for the first place. An AOI tuple corresponding to the first place can include activity points (e.g., as place profile data), as explained above. In this example, the computing system accesses the AOI tuple associated with the first place to access the activity points for the first place. In one example, activity points comprise locations where riders were picked up by one of a plurality of vehicles or dropped off by one of the plurality of vehicles.

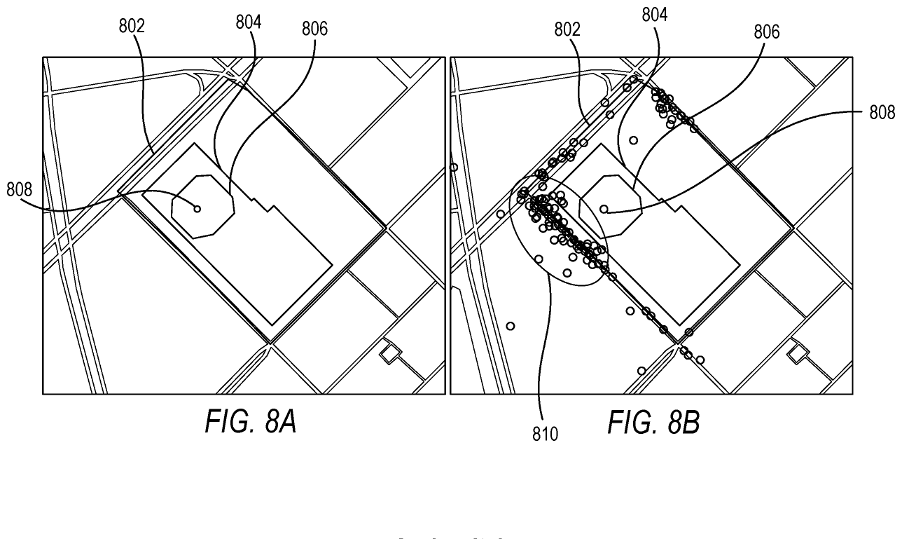

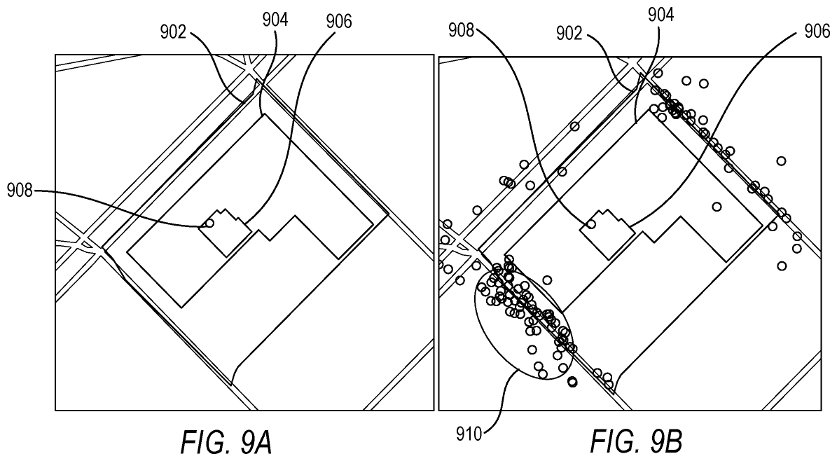

FIGS. 8A, 8B, 9A, and 9B show example images illustrating the map features and activity points conflated in the AOI tuple pipeline. For example, FIGS. 8A and 8B illustrate an example map of a place, in this case a business (e.g., the headquarters for a first company). FIG. 8A is a view without the activity points and includes an indication of the block 802, the parcel 804, and the BFP 806 for place 808. FIG. 8B shows the same information as FIG. 8A except it also includes the activity points scattered around and throughout the block 802, such as activity points 810.

FIGS. 9A and 9B illustrate an example map of a place, in this case another business (e.g., a location for a second company). FIG. 9A is a view without the activity points and includes an indication of the block 902, the parcel 904, and the BFP 906 for place 908. FIG. 9B shows the same information as FIG. 9A except it also include the activity points scattered around and throughout the block 902, such as activity points 910.

Returning to FIG. 7, in operation 704, the computing system determines selected activity points to use to generate one or more AOI geometries. In one example, activity points, such as pickup and drop-off points, are GPS traces from a computing device (e.g., client device 110) indicating a location of the computing device when a user was picked up, dropped off, and so forth. In some cases, some activity points may not be accurate. For example, accuracy of GPS goes down in downtown locations with lots of tall buildings, a user may choose to be dropped off a few blocks early before the actual destination, and so forth. Accordingly, the computing system determines selected activity points based on block, parcel, and BFP information for the place (e.g., contained in the AOI tuple associated with the place).

In one example, the computing system determines selected activity points to use to generate an AOI geometry by determining a largest area (e.g., oldest or highest area type) in a hierarchy of area types for the AOI tuple corresponding to the first place. For example, if the first place is represented by the hierarchy in FIG. 3, the largest area is the block 202. The computing system then determines the activity points that are located within the largest area of the AOI tuple. For example, if the largest area is a block, the computing system determines the activity points located within the block. If the largest area is a parcel or BFP, the computing system determines the activity points located within the parcel or BFP. In the example for the parcel or BFP, in one example, the computing system uses activity points that are inside the parcel or BFP geometry or that are within some distance r (e.g., a predefined distance) from the parcel or BFP geometry (e.g., r values: parcel—10 meters, or BFP—20 meters). The computing device selects the activity points located within the largest area for the AOI tuple to generate the AOI geometry.

In one example, there may not be a block, parcel, or BFP for the first place, but only coordinates for the first place (e.g., latitude/longitude coordinates), for example. In this case, the computing system uses (e.g., selects) the activity points (e.g., from the PlaceProfile) for the place as the activity points to generate the AOI geometry for the first place.

In another example, there may be too many activity points to process in a reasonable amount of time or with reasonable computing resources. For instance, the computing system may determine whether there is more than a predefined threshold number (e.g., 9000) of activity points located within the largest area for the AOI tuple. If the computing system determines that there is more than the predefined threshold number of activity points located within the largest area for the AOI tuple, the computing system takes a random sample of the activity points to generate a subset of the total activity points, the subset comprising a number of activity points less than the predefined threshold, and the computing device selects the subset of the total activity points to use to generate the AOI geometry.

In operation 706, the computing device generates the one or more AOI geometries using the selected activity points and using the AOI tuple associated with the first place. In one example embodiment, the computing system generates the one or more AOI geometries by generating one or more clusters of data points corresponding to the selected activity points and generating one or more polygons for each of the one or more clusters of data points. For example, the computing system uses a spatial-clustering or data-clustering algorithm (e.g., density-based spatial clustering of application with noise (DBSCAN), K-means) to generate the one or more clusters of data points. A spatial-clustering or data-clustering algorithm groups together points that are closely packed together. The result is one or more clusters comprising activity points associated with each of the one or more clusters. The computing system then uses an algorithm, such as convex hull as one example, to create a polygon for each of the clusters based on the activity points for each of the clusters. For example, the computing system uses the algorithm to capture the shape of each cluster. Each polygon is an AOI geometry for the place.

In one example, one or more of the polygons or AOI geometries may be merged. For example, the computing system determines whether any of the one or more polygons should be merged based on a distance between the polygons. For instance, if the polygons are less than a predefined distance or are touching or overlap with each other, they may be merged to form one polygon. Thus, the computing system merges the one or more polygons based on determining that the one or more polygons should be merged based on the distance between polygons.

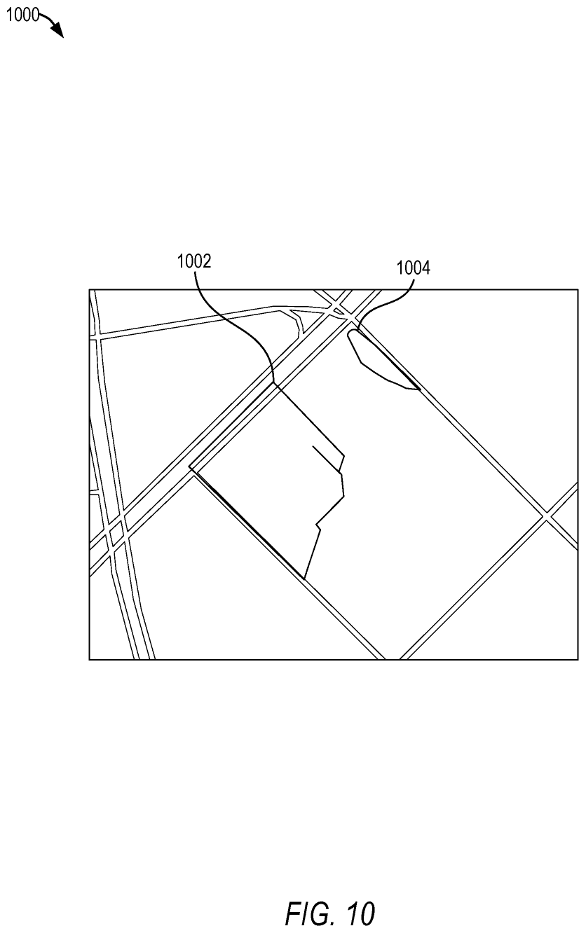

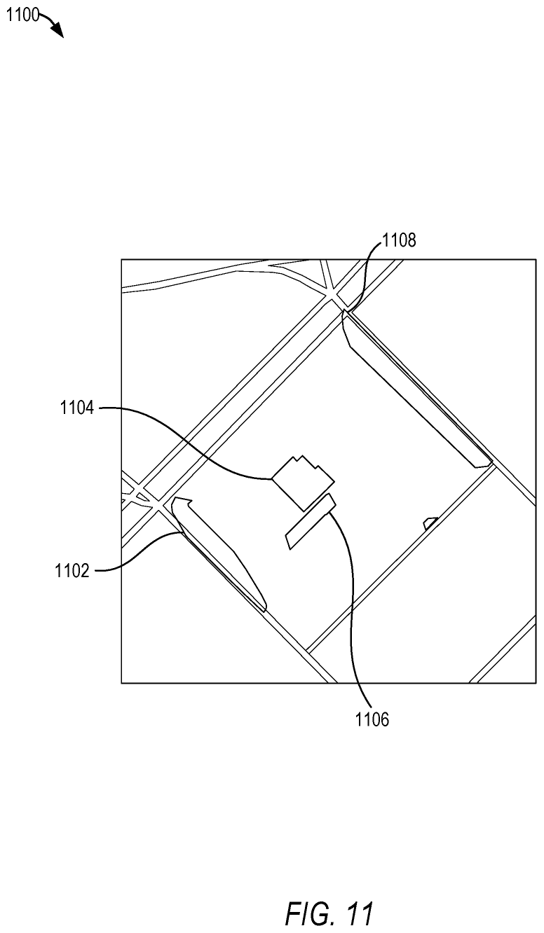

FIG. 10 and FIG. 11 illustrate examples of polygons (e.g., AOI geometries) generated from the clusters of activity points. FIG. 10 corresponds to the same place and activity points shown in FIGS. 8A and 8B, and FIG. 11 corresponds to the same place and activity points shown in FIGS. 9A and 9B. FIG. 10 shows two AOI geometries 1002 and 1004. FIG. 11 shows four AOI geometries 1102, 1104, 1106, and 1108.

Returning to FIG. 7, in operation 708, the computing system associates the one or more AOI geometries with the first place. Each of the one or more AOI geometries corresponds to each of the one or more polygons. The computing system stores the one or more AOI geometries for the first place. For example, the computing system can store the one or more AOI geometries as a list of AOI geometries for the place.

In one example, there may be less than a predefined number of selected activity points for a place. For example, there may not be enough activity points for a place to generate one or more useful AOI geometries. In this example, the computing system can generate one or more AOI geometries using a method (e.g., a Voronoi diagram or similar method) to partition an area based on the place location and nearby place locations in the block, parcel, or BFP. In this example, the computing system determines the block and BFP (or parcel if no BFP) for the place from the AOI tuple. The computing system then determines the BFP geometries of the AOI tuple's neighbors (other AOI tuple's for places in the block). The computing device computes the centroids of each of the BFP geometry and each neighbor's geometry. The computing device can then run the Voronoi Diagram Algorithm (or similar algorithm) on the centroids to get a list of Voronoi geometries which represent the Voronoi Diagram's regions. The computing device then determines the Voronoi geometry from the list that corresponds to the AOI tuple's BFP geometry based on spatial intersection with its centroid. Optionally the computing device can clean the selected Voronoi geometry by removing all intersections with neighboring geometries and by merging it with the AOI tuple's BFP geometry, as explained above. The result is a Voronoi-based AOI geometry for the place.

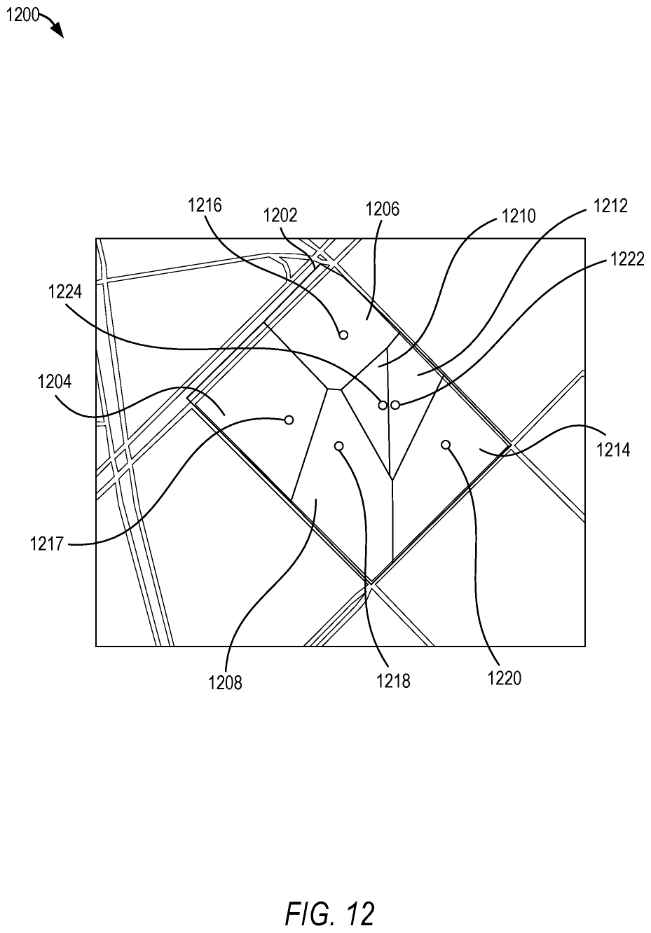

FIG. 12 illustrates an example 1200 showing Voronoi geometries 1204, 1206, 1208, 1210, 1212, and 1214, for different places 1216, 1218, 1220, 1222, and 1224, in a block 1202. As can be seen in FIG. 12, two of the places (e.g., coordinates for the places) are in the same parcel (e.g., 1222 and 1224) and have clearly defined regions.

In one example, AOI geometries for a place can be recalculated or regularly updated. For example, the AOI geometries may be recalculated on a predefined schedule (e.g., every few weeks, every month, every six months), based on detecting that activity points for a place are changing over time, based on determining that a place has moved or closed, and so forth.

Example embodiments can be used to enhance reverse geocoding, improve map displays, detect venue, sub-venue, and co-venue, and the like. For example, example embodiments can be used to improve zero query suggestions. For instance, AOI data can be used to improve the prediction for suggesting possible pickup points to a rider in a ride sharing or navigation system when a user first opens or starts up a ride sharing or navigation application on a user device (e.g., client device 110). For example, before a user types anything (e.g., no/zero query), the device or computing system can determine the present location of the user (e.g., via GPS technology of the user device), determine places surrounding that location, generate AOIs (e.g., AOI geometries) for the places, and rank a list of suggestions for the user.

In another example, example embodiments can decrease uncertainty in reverse geocoding by reducing cases of uncertainty when trying to reverse geocode. For instance, AOIs will give finer definitive regions to tie coordinates to AOIs when compared to other means, such as using parcels. Thus, instead of snapping coordinates corresponding to a user location to a parcel, for example, the computing system can determine AOIs for each place in the parcel. Since each place in the parcel will have its own AOI geometry, splitting the parcel into smaller distinct polygons (AOIs) allows the computing system to determine which place to return to the user for a pickup location.

In another example, AOIs can be used for a map display to contextualize pickup and drop-off areas for a driver and rider. When a driver is transporting his or her rider to their destination, he or she will be able to see an AOI for that destination. The app can show this region to the driver to help him or her determine the best drop off location given his or her current route and the rider's needs. This can also apply to the rider's side during pickup by using an AOI to show where the driver is looking for the rider.

In yet another example, AOIs can be used to detect venue, sub-venue, and co-venue relationships among multiple map entities. Using an example of a shopping plaza, which is represented as a parcel, and multiple stores, which are represented as BFPs, it is reasonable to assume that the AOI of the plaza entirely encompasses all the stores' AOIs, which means the computing system can establish a parent-child relationship with the parcel and BFPs, and thus can classify them as venue and sub-venue respectively. The stores can be classified as co-venues.

Example embodiments are described in a content of navigation and ride sharing systems. It is to be understood that example embodiments can be used in other use cases where an AOI geometry would be useful.

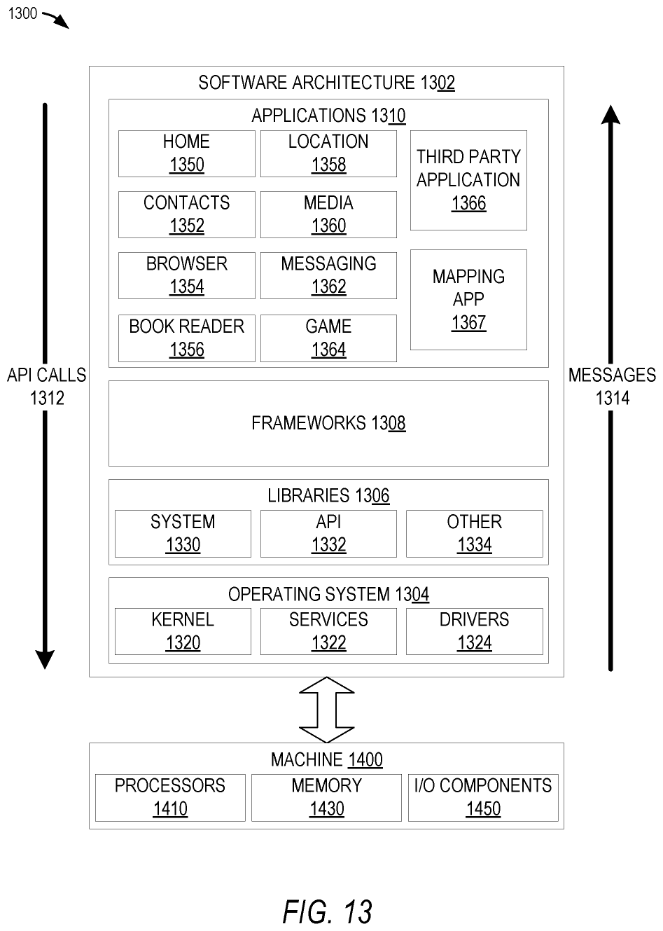

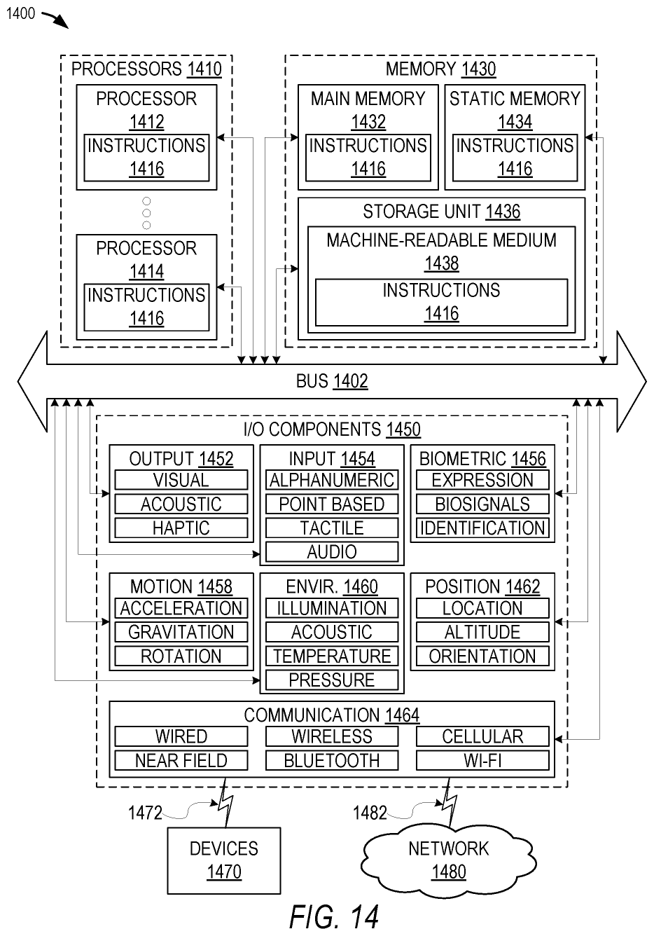

FIG. 13 is a block diagram 1300 illustrating a software architecture 1302, which can be installed on any one or more of the devices described above. For example, in various embodiments, client devices 110 and servers and systems 130, 102, 120, 122, and 124 may be implemented using some or all of the elements of the software architecture 1302. FIG. 13 is merely a non-limiting example of a software architecture, and it will be appreciated that many other architectures can be implemented to facilitate the functionality described herein. In various embodiments, the software architecture 1302 is implemented by hardware such as a machine 1400 of FIG. 14 that includes processors 1410, memory 1430, and I/O components 1450. In this example, the software architecture 1302 can be conceptualized as a stack of layers where each layer may provide a particular functionality. For example, the software architecture 1302 includes layers such as an operating system 1304, libraries 1306, frameworks 1308, and applications 1310. Operationally, the applications 1310 invoke application programming interface (API) calls 1312 through the software stack and receive messages 1314 in response to the API calls 1312, consistent with some embodiments.

In various implementations, the operating system 1304 manages hardware resources and provides common services. The operating system 1304 includes, for example, a kernel 1320, services 1322, and drivers 1324. The kernel 1320 acts as an abstraction layer between the hardware and the other software layers, consistent with some embodiments. For example, the kernel 1320 provides memory management, processor management (e.g., scheduling), component management, networking, and security settings, among other functionality. The services 1322 can provide other common services for the other software layers. The drivers 1324 are responsible for controlling or interfacing with the underlying hardware, according to some embodiments. For instance, the drivers 1324 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 1306 provide a low-level common infrastructure utilized by the applications 1310. The libraries 1306 can include system libraries 1330 (e.g., C standard library) that can provide functions such as memory allocation functions, string manipulation functions, mathematical functions, and the like. In addition, the libraries 1306 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 1306 can also include a wide variety of other libraries 1334 to provide many other APIs to the applications 1310.

The frameworks 1308 provide a high-level common infrastructure that can be utilized by the applications 1310, according to some embodiments. For example, the frameworks 1308 provide various graphic user interface (GUI) functions, high-level resource management, high-level location services, and so forth. The frameworks 1308 can provide a broad spectrum of other APIs that can be utilized by the applications 1310, some of which may be specific to a particular operating system 1304 or platform.

In an example embodiment, the applications 1310 include a home application 1350, a contacts application 1352, a browser application 1354, a book reader application 1356, a location application 1358, a media application 1360, a messaging application 1362, a game application 1364, and a broad assortment of other applications, such as a third-party application 1366. According to some embodiments, the applications 1310 are programs that execute functions defined in the programs. Various programming languages can be employed to create one or more of the applications 1310, structured in a variety of manners, such as object-oriented programming languages (e.g., Objective-C, Java, or C++) or procedural programming languages (e.g., C or assembly language). In a specific example, the third-party application 1366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1366 can invoke the API calls 1312 provided by the operating system 1304 to facilitate functionality described herein.

Some embodiments may particularly include a mapping application 1367. In certain embodiments, this may be a standalone application that operates to manage communications with a server system such as third-party servers 130 or server system 102. In other embodiments, this functionality may be integrated with another application. The mapping application 1367 may request and display various data related to mapping and navigation and may provide the capability for a user 106 to input data related to the objects via a touch interface, via a keyboard, or using a camera device of the machine 1400, communication with a server system via the I/O components 1450, and receipt and storage of object data in the memory 1430. Presentation of information and user inputs associated with the information may be managed by the mapping application 1367 using different frameworks 1308, library 1306 elements, or operating system 1304 elements operating on the machine 1400.

FIG. 14 is a block diagram illustrating components of a machine 1400, according to some embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system within which instructions 1416 (e.g., software, a program, an application 1310, an applet, an app, or other executable code) for causing the machine 1400 to perform any one or more of the methodologies discussed herein can be executed. In alternative embodiments, the machine 1400 operates as a standalone device or can be coupled (e.g., networked) to other machines. In a networked deployment, the machine 1400 may operate in the capacity of a server machine or system 130, 102, 120, 122, 124, etc., or a client device 110 in a server-client network environment, or as a peer machine in a peer-to-peer (or distributed) network environment. The machine 1400 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

In various embodiments, the machine 1400 comprises processors 1410, memory 1430, and I/O components 1450, which can be configured to communicate with each other via a bus 1402. In an example embodiment, the processors 1410 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 1412 and a processor 1414 that may execute the instructions 1416. The term “processor” is intended to include multi-core processors 1410 that may comprise two or more independent processors 1412, 1414 (also referred to as “cores”) that can execute instructions 1416 contemporaneously. Although FIG. 14 shows multiple processors 1410, the machine 1400 may include a single processor 1410 with a single core, a single processor 1410 with multiple cores (e.g., a multi-core processor 1410), multiple processors 1412, 1414 with a single core, multiple processors 1412, 1414 with multiple cores, or any combination thereof.

The memory 1430 comprises a main memory 1432, a static memory 1434, and a storage unit 1436 accessible to the processors 1410 via the bus 1402, according to some embodiments. The storage unit 1436 can include a machine-readable medium 1438 on which are stored the instructions 1416 embodying any one or more of the methodologies or functions described herein. The instructions 1416 can also reside, completely or at least partially, within the main memory 1432, within the static memory 1434, within at least one of the processors 1410 (e.g., within the processor's cache memory), or any suitable combination thereof, during execution thereof by the machine 1400. Accordingly, in various embodiments, the main memory 1432, the static memory 1434, and the processors 1410 are considered machine-readable media 1438.

As used herein, the term “memory” refers to a machine-readable medium 1438 able to store data temporarily or permanently and may be taken to include, but not be limited to, random-access memory (RAM), read-only memory (ROM), buffer memory, flash memory, and cache memory. While the machine-readable medium 1438 is shown, in an example embodiment, to be a single medium, the term “machine-readable medium” should be taken to include a single medium or multiple media (e.g., a centralized or distributed database, or associated caches and servers) able to store the instructions 1416. The term “machine-readable medium” shall also be taken to include any medium, or combination of multiple media, that is capable of storing instructions (e.g., the instructions 1416) for execution by a machine (e.g., the machine 1400), such that the instructions, when executed by one or more processors of the machine (e.g., the processors 1410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1450 include a wide variety of components to receive input, provide output, produce output, transmit information, exchange information, capture measurements, and so on. In general, it will be appreciated that the I/O components 1450 can include many other components that are not shown in FIG. 14. The I/O components 1450 are grouped according to functionality merely for simplifying the following discussion, and the grouping is in no way limiting. In various example embodiments, the I/O components 1450 include output components 1452 and input components 1454. The output components 1452 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1454 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touchscreen that provides location and force of touches or touch gestures, or other tactile input components), audio input components (e.g., a microphone), and the like.

In some further example embodiments, the I/O components 1450 include biometric components 1456, motion components 1458, environmental components 1460, or position components 1462, among a wide array of other components. For example, the biometric components 1456 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1458 include acceleration sensor components (e.g., accelerometer), gravitation sensor components, rotation sensor components (e.g., gyroscope), and so forth. The environmental components 1460 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1462 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1450 may include communication components 1464 operable to couple the machine 1400 to a network 1480 or devices 1470 via a coupling 1482 and a coupling 1472, respectively. For example, the communication components 1464 include a network interface component or another suitable device to interface with the network 1480. In further examples, the communication components 1464 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1470 may be another machine 1400 or any of a wide variety of peripheral devices (e.g., a peripheral device coupled via a Universal Serial Bus (USB)).

Moreover, in some embodiments, the communication components 1464 detect identifiers or include components operable to detect identifiers. For example, the communication components 1464 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D barcodes, and other optical codes), acoustic detection components (e.g., microphones to identify tagged audio signals), or any suitable combination thereof. In addition, a variety of information can be derived via the communication components 1464, such as location via Internet Protocol (IP) geo-location, location via WI-FT® signal triangulation, location via detecting a BLUETOOTH® or NFC beacon signal that may indicate a particular location, and so forth.

In various example embodiments, one or more portions of the network 1480 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 1480 or a portion of the network 1480 may include a wireless or cellular network, and the coupling 1482 may be a Code Division Multiple Access (CDMA) connection, a Global System for Mobile communications (GSM) connection, or another type of cellular or wireless coupling. In this example, the coupling 1482 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 1416 are transmitted or received over the network 1480 using a transmission medium via a network interface device (e.g., a network interface component included in the communication components 1464) and utilizing any one of a number of well-known transfer protocols (e.g., Hypertext Transfer Protocol (HTTP)). Similarly, in other example embodiments, the instructions 1416 are transmitted or received using a transmission medium via the coupling 1472 (e.g., a peer-to-peer coupling) to the devices 1470. The term “transmission medium” shall be taken to include any intangible medium that is capable of storing, encoding, or carrying the instructions 1416 for execution by the machine 1400, and includes digital or analog communications signals or other intangible media to facilitate communication of such software.

Furthermore, the machine-readable medium 1438 is non-transitory (in other words, not having any transitory signals) in that it does not embody a propagating signal. However, labeling the machine-readable medium 1438 “non-transitory” should not be construed to mean that the medium is incapable of movement; the machine-readable medium 1438 should be considered as being transportable from one physical location to another. Additionally, since the machine-readable medium 1438 is tangible, the machine-readable medium 1438 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
accessing at least one data store comprising activity points for a first place;
determining selected activity points to use to generate one or more area of influence (AOI) geometries;
generating one or more AOI geometries using the selected activity points and using an AOI tuple associated with the first place, by performing operations comprising:
generating one or more clusters of data points corresponding to the selected activity points; and
generating one or more polygons for each of the one or more clusters of data points;
associating the one or more AOI geometries with the first place, each of the one or more AOI geometries comprising each of the one or more polygons; and
storing the one or more AOI geometries for the first place.

2. The method of claim 1, wherein the activity points comprise locations where riders were picked up or dropped off.

3. The method of claim 1, wherein determining the selected activity points to use to generate the one or more AOI geometries comprises:
determining a largest area in a hierarchy of area types for the AOI tuple;
determining the activity located within the largest area for the AOI tuple; and
setting the selected activity points to the activity points located within the largest area for the AOI tuple.

4. The method of claim 3, wherein the area types comprise at least one of a block, parcel, or building footprint.

5. The method of claim 4, wherein the largest area in the hierarchy of area types for the AOI tuple is a block, and wherein determining the activity points located within the largest area for the AOI tuple comprises determining the activity points located within the block.

6. The method of claim 4, wherein the largest area in the hierarchy of area types for the AOI tuple is a parcel, and wherein determining the activity points located within the largest area for the AOI tuple comprises determining the activity points located within the parcel.

7. The method of claim 4, wherein the largest area in the hierarchy of area types for the AOI tuple is a building footprint, and wherein determining the activity points located within the largest area for the AOI tuple comprises determining the activity points located within the building footprint.

8. The method of claim 3, further comprising:
determining that there are more than a predefined threshold number of activity points located within the largest area for the AOI tuple;
taking a random sample of the activity points to generate a subset of total activity points; and
setting the subset of the total activity points as the selected activity points.

9. The method of claim 1, further comprising:
determining that there is less than a predefined number of selected activity points for the first place; and
generating the one or more AOI geometries using a Voronoi diagram.

10. The method of claim 1, further comprising:
determining whether any of the one or more polygons should be merged based on distance between polygons; and
merging one or more of the polygons based on determining that the one or more polygons should be merged based on the distance between polygons, wherein the one or more AOI geometries comprise the merged polygons.

11. A computing system comprising:
a memory that stores instructions; and
one or more processors configured by the instructions to perform operations comprising:
accessing at least one data store comprising activity points for a first place;
determining selected activity points to use to generate one or more area of influence (AOI) geometries;
generating one or more AOI geometries using the selected activity points and using an AOI tuple associated with the first place, by performing operations comprising:
generating one or more clusters of data points corresponding to the selected activity points; and
generating one or more polygons for each of the one or more clusters of data points;
associating the one or more AOI geometries with the first place, each of the one or more AOI geometries comprising each of the one or more polygons; and
storing the one or more AOI geometries for the first place.

12. The computing system of claim 11, wherein the activity points comprise locations where riders were picked up or dropped off.

13. The computing system of claim 11, wherein determining the selected activity points to use to generate the one or more AOI geometries comprises:
determining a largest area in a hierarchy of area types for the AOI tuple;
determining the activity located within the largest area for the AOI tuple; and
setting the selected activity points to the activity points located within the largest area for the AOI tuple.

14. The computing system of claim 13, wherein the area types comprise at least one of a block, parcel, or building footprint.

15. The computing system of claim 14, wherein the largest area in the hierarchy of area types for the AOI tuple is a block, and wherein determining the activity points located within the largest area for the AOI tuple comprises determining the activity points located within the block.

16. The computing system of claim 14, wherein the largest area in the hierarchy of area types for the AOI tuple is a parcel, and wherein determining the activity points located within the largest area for the AOI tuple comprises determining the activity points located within the parcel.

17. The computing system of claim 14, wherein the largest area in the hierarchy of area types for the AOI tuple is a building footprint, and wherein determining the activity points located within the largest area for the AOI tuple comprises determining the activity points located within the building footprint.

18. The computing system of claim 13, the operations further comprising:
determining that there are more than a predefined threshold number of activity points located within the largest area for the AOI tuple;
taking a random sample of the activity points to generate a subset of total activity points; and
setting the subset of the total activity points as the selected activity points.

19. The computing system of claim 11, the operations further comprising:
determining that there is less than a predefined number of selected activity points for the first place; and
generating the one or more AOI geometries using a Voronoi diagram.

20. A non-transitory computer-readable medium comprising instructions stored thereon that are executable by at least one processor to cause a computing system to perform operations comprising:
accessing at least one data store comprising activity points for a first place;
determining selected activity points to use to generate one or more area of influence (AOI) geometries;
generating one or more AOI geometries using the selected activity points and using an AOI tuple associated with the first place, by performing operations comprising:
generating one or more clusters of data points corresponding to the selected activity points; and
generating one or more polygons for each of the one or more clusters of data points;
associating the one or more AOI geometries with the first place, each of the one or more AOI geometries comprising each of the one or more polygons; and
storing the one or more AOI geometries for the first place.
